(19) United States
(12) Patent Application Publication
(10) Pub. No.: US 2015/0322387 A1
(43) Pub. Date: Nov. 12, 2015

(54) ANTI-MICROBIAL CLEANING COMPOSITION

(71) Applicant: The Procter & Gamble Company, Cincinnati, OH (US)

(72) Inventors: Ryohei OHTANI, Nishinomiya (JP); Fei LI, Beijing (CN); Qiupeng YAO, Beijing (CN); Yoshiki ISHIDA, Singapore (SG)

(21) Appl. No.: 14/708,358

(22) Filed: May 11, 2015

(30) Foreign Application Priority Data
May 12, 2014 (WO) CN2014/077257

(51) Int. Cl. C11D 3/48; C11D 17/04; C11D 3/37; C11D 1/83; A01N 31/16; C11D 3/20

(52) U.S. Cl. CPC C11D 3/48; A01N 31/16; C11D 3/2068; C11D 3/3723; C11D 1/83; C11D 17/042

(57) ABSTRACT

An anti-microbial cleaning composition, comprising: by weight of the composition, from 0.001% to 3% of a nonionic anti-microbial agent, and from 0.1% to 3% of a soil dispersant. The anti-microbial cleaning composition provides desired performance in both cleaning and anti-microbial aspects.

### FIELD OF THE INVENTION

The present invention relates to an anti-microbial cleaning composition.

### BACKGROUND OF THE INVENTION

Various technologies have been utilized to improve the cleaning performance of cleaning products such as laundry detergents or hair shampoos. For example, certain polymers (e.g., polyethyleneimine branched with ethyleneoxy side chains) can function as a soil dispersant when incorporated into a laundry detergent composition. During a washing cycle, the polymers drive soil removal, and stabilize the detached soil in the washing solution and prevent it from re-depositing onto fabrics. Thus, such soil dispersants significantly improve the cleaning performance of the products.

Also, cleaning compositions have evolved to address user needs for an anti-microbial benefit, in addition to their original intended functions (namely, the cleaning function). For example, an anti-microbial laundry detergent product is desired by users as it cleans fabrics whilst having an anti-microbial benefit on fabrics. Currently, various anti-microbial agents are known for use in cleaning formulations to deliver an anti-microbial effect. Upon depositing onto a treated situs, such anti-microbial agents either damage the bacteria envelope to kill bacteria, or denature the bacteria envelope to prevent bacteria growth or reproduction, thereby delivering the anti-microbial benefit. To deliver a desired anti-microbial effect towards a treated situs (e.g., a treated fabric), a sufficient amount of the anti-microbial agents needs to be deposited onto the situs during a cleaning cycle. However, the deposition of the anti-microbial agents onto the treated situs is negatively impacted by the aforementioned soil dispersants that are added to counter the re-deposition of soils. In other words, it is challenging in the art to achieve both a desired cleaning performance and an anti-microbial benefit for cleaning compositions.

Thus, there is a need for a cleaning composition that provides desired performance in both cleaning and anti-microbial aspects.

It is a further advantage of the present invention to provide a stable, liquid anti-microbial cleaning composition.

### SUMMARY OF THE INVENTION

The present invention is directed to an anti-microbial cleaning composition, comprising:

a) from 0.001% to 3%, by weight of the cleaning composition, of a nonionic anti-microbial agent; and

b) from 0.1% to 3%, by weight of the composition, of a soil dispersant comprising an alkylene amine backbone and a side chain bonded to the nitrogen atom of the alkylene amine backbone, wherein the side chain is of formula (I),

-(EO)_{b}(PO)_{c} (I)

wherein b ranges from 3 to 60, and c ranges from 0 to 60.

### DETAILED DESCRIPTION OF THE INVENTION

In the present invention, it has been surprisingly found that, by utilizing the specific anti-microbial agent and soil dispersant at certain levels, the negative impact on the deposition of the anti-microbial agent caused by the soil dispersant is minimized. Meanwhile, the incorporated soil dispersant delivers improved cleaning performance. Thus, a cleaning composition having both good cleaning and anti-microbial performance is obtained. Without wishing to be bound by theory, it is believed that when the soil dispersant is present at a relatively low level, the anti-microbial agent exists in the washing solution without being captured by the soil dispersant. Such free anti-microbial agent then can deposit onto treated fabrics effectively, thereby delivering a desired anti-microbial effect.

### DEFINITIONS

As used herein, the term “cleaning composition” means a composition relating to cleaning or treating: fabrics, hard or soft surfaces, skin, hair, or any other surfaces in the area of fabric care, home care, skin care, and hair care. Examples of the cleaning compositions include, but are not limited to: laundry detergent, laundry detergent additive, fabric softener, carpet cleaner, floor cleaner, bathroom cleaner, toilet cleaner, sink cleaner, dishwashing detergent, air care, car care, skin moisturizer, skin cleanser, skin treatment emulsion, shaving cream, hair shampoo, hair conditioner, and the like. Preferably, the cleaning composition is a liquid cleaning composition, more preferably is a liquid laundry detergent composition, a liquid fabric softener composition, a liquid dishwashing detergent composition, or a hair shampoo, even more preferably is a liquid laundry detergent composition. The term “liquid cleaning composition” herein refers to compositions that are in a form selected from the group consisting of pourable liquid, gel, cream, and combinations thereof. The liquid cleaning composition may be either aqueous or non-aqueous, and may be anisotropic, isotropic, or combinations thereof.

As used herein, the term “anti-microbial agent” refers to a chemical compound of which the principle intended function is to kill bacteria or to prevent their growth or reproduction. Traditional anti-microbial agents include cationic anti-microbial agents (e.g., certain ammonium chlorides), nonionic anti-microbial agents, etc. Diphenyl ether compounds that are preferably used in the present invention are nonionic anti-microbial agents.

As used herein, the term “situs” includes fabrics, paper products, garments, hard surfaces, hair and skin.

As used herein, the term “washing solution” refers to the typical amount of aqueous solution used for one cycle of laundry washing, preferably from 1 L to 50 L, alternatively from 1 L to 20 L for hand washing and from 20 L to 50 L for machine washing.

As used herein, the term “alkyl” means a hydrocarbyl moiety which is branched or unbranched, substituted or unsubstituted. Included in the term “alkyl” is the alkyl portion of acyl groups.

As used herein, when a composition is “substantially free” of a specific ingredient, it is meant that the composition comprises less than a trace amount, alternatively less than 0.1%, alternatively less than 0.01%, alternatively less than 0.001%, by weight of the composition, of the specific ingredient.

As used herein, the articles including “a” and “an” when used in a claim, are understood to mean one or more of what is claimed or described.

As used herein, the terms “comprise”, “comprises”, “comprising”, “include”, “includes”, “including”, “contain”, “contains”, and “containing” are meant to be non-limiting, i.e., other steps and other ingredients which do not affect the end of result can be added. The above terms encompass the terms “consisting of” and “consisting essentially of”.

### Anti-Microbial Cleaning Composition

The anti-microbial cleaning composition of the present invention comprises: by weight of the composition, from 0.001% to 3% of a nonionic anti-microbial agent, and from 0.1% to 3% of a soil dispersant comprising an alkylene amine backbone and a side chain bonded to the nitrogen atom of the alkylene amine backbone. The side chain is of formula (I),

-(EO)_{b}(PO)_{c} (I)

wherein b ranges from 3 to 60, and c ranges from 0 to 60.

Preferably in the cleaning composition, the nonionic anti-microbial agent is present from 0.01% to 1%, more preferably from 0.03% to 0.5%, by weight of the composition. The soil dispersant is preferably present from 0.2% to 2%, more preferably from 0.3% to 1.5%, by weight of the composition.

In a washing solution, the cleaning composition is preferably capable of delivering the anti-microbial agent at a level from 0.01 ppm to 5 ppm, more preferably from 0.05 ppm to 3 ppm, more preferably from 0.1 ppm to 1 ppm.

The laundry detergent composition herein provides anti-microbial benefits against both Gram positive bacteria (e.g., Staphylococcus aureus) and Gram negative bacteria (e.g., Klebsiella pneumoniae). The composition preferably provides residual anti-microbial benefits to the fabrics treated by the composition, i.e., the nonionic anti-microbial agent therein deposits onto the fabrics during a washing cycle and subsequently the deposited (i.e., residual) antimicrobial-agent prevents bacteria growth onto the fabrics during drying or storage or wear. In one embodiment, the laundry detergent composition provides a Bacteriostatic Activity Value of at least a log 2.2 reduction, preferably a log 2.5 reduction, against both Gram positive bacteria and Gram negative bacteria, to treated fabrics versus non-treated fabrics. Preferably, the composition provides at least a log 2.2 reduction, preferably a log 2.5 reduction, against Staphylococcus aureus and/or Klebsiella pneumoniae after a 10 minutes contact time in a 2069 ppm aqueous solution as determined by the JISL 1902 method (that is described below). More preferably, the composition provides at least a log 3.0 reduction, preferably a log 3.5 reduction, against Staphylococcus aureus. It is worth noting that Staphylococcus aureus is frequently found on human skin and therefore fabrics (particularly wearing fabrics) are in particular need of anti-microbial effects against Staphylococcus aureus.

The laundry detergent composition herein may be acidic or alkali or pH neutral, depending on the ingredients incorporated in the composition. The pH range of the laundry detergent composition is preferably from 6 to 12, more preferably from 7 to 11, even more preferably from 8 to 10.

In the execution of liquid cleaning composition, the composition can have any suitable viscosity depending on factors such as formulated ingredients and purpose of the composition. In one embodiment, the composition has a high shear viscosity value, at a shear rate of 20/sec and a temperature of 21° C., of 200 to 3,000 cP, alternatively 300 to 2,000 cP, alternatively 500 to 1,000 cP, and a low shear viscosity value, at a shear rate of 1/sec and a temperature of 21° C., of 500 to 100,000 cP, alternatively 1000 to 10,000 cP, alternatively 1,500 to 5,000 cP.

### Nonionic Anti-Microbial Agent

The anti-microbial agent of the present invention is nonionic. In the present invention, it has been found that due to its nonionic property, the anti-microbial agent of the present invention allows for a stable anti-microbial cleaning composition, particularly in a context of liquid composition. By contrast, traditional cationic anti-microbial agents are typically not compatible with anionic surfactants present in the cleaning compositions.

The anti-microbial agent is preferably a diphenyl ether, more preferably a hydroxyl diphenyl ether. The nonionic anti-microbial agent herein can be either halogenated or non-halogenated, but preferably is halogenated. Diphenyl ethers suitable for use herein are described from Col. 1, line 54 to Col. 5, line 12 in U.S. Pat. No. 7,041,631B, which is incorporated by reference.

In one embodiment, the nonionic anti-microbial agent is a hydroxyl diphenyl ether of formula (II):

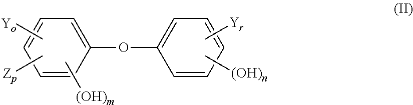

each Y is independently selected from chlorine, bromine, or fluorine, preferably is chlorine or bromine, more preferably is chlorine,
each Z is independently selected from SO₂H, NO₂, or C₁-C₄ alkyl,
r is 0, 1, 2, or 3, preferably is 1 or 2,
o is 0, 1, 2, or 3, preferably is 0, 1 or 2,
p is 0, 1, or 2, preferably is 0,
m is 1 or 2, preferably is 1, and
n is 0 or 1, preferably is 0.

In the above definition for formula (II), 0 means nil. For example, when p is 0, then there is no Z in formula (II). Each Y or Z could be the same or different. In one embodiment, o is 1, r is 2, and Y is chlorine or bromine. This embodiment could be: one chlorine atom bonds to a benzene ring while the bromine atom and the other chlorine atom bond to the other benzene ring; or the bromine atom bonds to a benzene ring while the two chlorine atoms bond to the other benzene ring.

Preferably, the nonionic anti-microbial agent herein is selected from the group consisting of 4-4′-dichloro-2-hydroxy diphenyl ether (“Diclosan”), 2,4,4′-trichloro-2′-hydroxy diphenyl ether (“Triclosan”), and a combination thereof. Most preferably, the anti-microbial agent is 4-4′-dichloro-2-hydroxy diphenyl ether, commercially available from BASF, under the trademark name Tinosan®HP100.

In addition to the diphenyl ether, other anti-microbial agents may also be present, provided that these are not present at a level which causes instability in the formulation. Among such useful further antimicrobial agents are chelating agents, which are particularly useful in reducing the resistance of Gram negative microbes in hard water. Acid biocides may also be present.

### Soil Dispersant

The soil dispersant of the present invention comprises an alkylene amine backbone and a side chain bonded to the nitrogen atom of the alkylene amine backbone, wherein the side chain is of formula (I),

-(EO)_{b}(PO)_{c} (I)

wherein b represents the number of ethyleneoxy (“EO”) units connecting to a nitrogen atom of the alkylene amine backbone and ranges from 3 to 60, and c represents the number of propyleneoxy (“PO”) units (if any) connecting to the EO units and ranges from 0 to 60. Without wishing to be bound by theory, it is believed that due to the hydrophilic EO chain, the soil dispersant herein detaches soils from a treated fabric and prevents them from re-depositing onto the fabric.

The backbone used for the soil dispersant herein can be any suitable alkylene amines (e.g., ethylene amines, propylene amines), including quaternized and non-quaternized amines. The backbone can comprise a single alkylene amine or multiple alkylene amines as in a polymer (e.g., polyalkyleneimine). In the execution of the multiple alkylene amines as the backbone, at least one nitrogen atom of the backbone is bonded by side chain of formula (I), preferably multiple nitrogen atoms of the backbone are each bonded by side chain of formula (I), i.e., there are multiple side chains of formula (I) present in the soil dispersant molecule. When bonded by side chain of formula (I), a nitrogen atom can be bonded by one or two side chains of formula (I) depending on whether the nitrogen atom is at an internal position or at a terminal position of the backbone. In term of the number of the side chains in the soil dispersant molecule, there can be from one to hundreds, depending on factors including the size of the backbone, the number of available nitrogen atoms in the backbone, etc. For example, in the polyalkyleneimine execution, the number of the side chains can be from one or hundreds, preferably from 5 to 80, alternatively from 10 to 50.

Preferably, the soil dispersant herein comprises a compound selected from the group consisting of:

a) a polyethyleneimine ethoxylate, having polyethyleneimine (PEI) as a backbone and a side chain of formula (I) bonded to a nitrogen atom of the PEI backbone, preferably two or more side chains of formula (I) bonded to two or more nitrogen atoms of the PEI backbone, respectively,

-(EO)_{b}(PO)_{c} (I)
wherein b ranges from 3 to 60, and c ranges from 0 to 60;

b) a compound of formula (III),

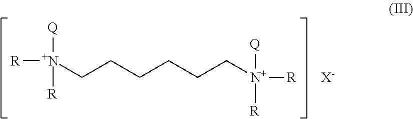

wherein R is an ethyleneoxy unit of formula (IV):

-(EO)ₙR⁴ (IV)
wherein n ranges from 3 to 50; R⁴ is hydrogen, an anionic unit, or a combination thereof; Q is a quaternizing unit independently selected from the group consisting of C₁-C₈ linear alkyl, C₃-C₈ branched alkyl, benzyl, and mixtures thereof; and X is a water soluble anion; and

a combination thereof.

Polyethyleneimine Ethoxylate In the polyethyleneimine ethoxylate, the PEI backbone can be either linear or cyclic or the combination thereof. The PEI backbone can also comprise PEI branching chains to a greater or lesser degree. In general, the PEI backbone described herein are modified in such a manner that each nitrogen atom of the PEI chain is thereafter described in terms of a unit that is substituted, quaternized, oxidized, or combinations thereof. The PEI backbone has an average number-average molecular weight, MWₙ, prior to modification and exclusive of the side chains, ranging from about 100 to about 100,000, preferably from about 200 to about 10,000, more preferably from 300 to about 3,000.

Without wishing to be bound by theory, it is believed that in typical wash conditions where the pH of the washing solution is around 8, the nitrogen atoms of the PEI backbone are partially protonated. Such, during the wash cycle, the PEI backbone deposits onto soils (e.g., clays) and penetrates imperfections such as cracks and crevasses. The penetration of the PEI backbone, in combination with the hydrophilic ethyleneoxy chain that extends outward from the soil surface, further enhances the clay removal performance.

In formula (I),

-(EO)_{b}(PO)_{c} (I)

b represents the average number of EO units per nitrogen atom in the PEI backbone and ranges from 3 to 60, preferably from 5 to 50, more preferably from 15 to 35; and c represents the average number of PO units per nitrogen atom in the PEI backbone and ranges from 0 to 60.

The polyethyleneimine ethoxylate herein can be divided to two sub-groups depending on the value of c in formula (I): when c is 0, and when c ranges from 1 to 60.

In the execution where c is 0, the compound does not have a PO unit. This type of compound and the manufacturing process thereof are generally described in U.S. Pat. No. 6,087,316. One preferred example of such type of soil dispersant is a polyethyleneimine corresponding to formula (I) having a PEI backbone with an average number-average molecular weight of about 600 which is ethoxylated to a level of about 20 EO units per PEI nitrogen atom.

Alternatively in the execution when c is from 1 to 60, the compound has one or more PO units. The PO unit is hydrophobic and therefore renders the soil dispersant an amphiphilic property, in combination with the hydrophilic EO chain. By adjusting the number of the EO and PO units in the compound, the compound herein can achieve balanced hydrophilic and hydrophobic properties, thereby boosting overall cleaning on surfactant sensitive stains such as grease/oils. In one embodiment, c ranges from 5 to 40, preferably from 10 to 25. This type of compound and the manufacturing process thereof are generally described in U.S. Pat. No. 8,097,579. One preferred embodiment of such type of soil dispersant is a polyethyleneimine corresponding to Formula (I) having a PEI backbone with an average number-average molecular weight of about 600 which is ethoxylated to a level of about 30 EO units per PEI nitrogen atoms and propoxylated to a level of about 5 PO units per PEI nitrogen atom.

These PEI backbones can be prepared, for example, by polymerizing ethyleneimine in the presence of a catalyst such as carbon dioxide, sodium bisulfite, sulfuric acid, hydrogen peroxide, hydrochloric acid, acetic acid, and the like. Specific methods for preparing these PEI backbones are disclosed in U.S. Pat. No. 2,182,306, Ulrich et al., issued Dec. 5, 1939; U.S. Pat. No. 3,033,746, Mayle et al., issued May 8, 1962; U.S. Pat. No. 2,208,095, Esselmann et al., issued Jul. 16, 1940; U.S. Pat. No. 2,806,839, Crowther, issued Sep. 17, 1957; and U.S. Pat. No. 2,553,696, Wilson, issued May 21, 1951. The PEI backbones are then modified by ethoxylation and optional propoxylation to obtain the polyethyleneimine ethoxylate.

Compound of Formula (III)

The compound of formula (III) is a zwitterionic hexamethylene diamine, comprising a quaternized diamine backbone and extended EO chains. Such a zwitterionic hexamethylene diamine and the manufacturing process thereof are generally described in U.S. Pat. No. 6,444,633. Without wishing to be bound by theory, it is believed that the quaternized diamine backbone absorbs effectively onto clay platelets while the EO chains detach clays and stabilizes the detached clays from re-desposition.

In formula (III),

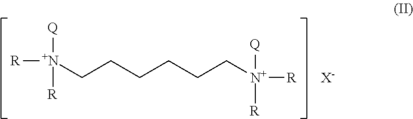

R is an ethyleneoxy unit of formula (IV):

-(EO)ₙR⁴ (IV)

wherein n represents the average number of EO units and ranges from 3 to 50. Depending upon the method by which the formulator chooses to form the EO units, the wider or narrower the range of EO units present. Preferably the range of EO units in plus or minus two units, more preferably plus or minus one unit. Most preferably each R group comprises the same number of EO units. The index n is preferably from 10 to 40, more preferably from 15 to 35. A preferred value for n is 24;

R⁴ is hydrogen, an anionic unit, or a combination thereof. Non-limiting examples of anionic units include —(CH₂)ₚCO₂M; —(CH₂)_{q}SO₃M; —(CH₂)_{q}CH(SO₂M)-CH₂SO₃M; —(CH₂)_{q}CH(OSO₂M)CH₂OSO₃M; —(CH₂)_{q}CH(SO₃M)CH₂SO₃M; —(CH₂)ₚPO₃M; —PO₃M; and mixtures thereof; wherein M is hydrogen or a water soluble cation in sufficient amount to satisfy charge balance. Preferred anionic units are —(CH₂)ₚCO₂M or —(CH₂)_{q}SO₃M, more preferably —(CH₂)_{q}SO₃M. The indices p and q are integers from 0 to 6. Preferably from about 85%, more preferably from about 90%, most preferably from about 95% of all R⁴ units which comprise an aggregate sample of the zwitterionic diamine have R⁴ units which are anionic units. It will be understood by the formulator that some molecules will be fully capped with anionic units, while some molecules may have two R⁴ units which are hydrogen. However, most preferably from about 95% of all R units present will be capped with one or more anionic units described herein;

Q is a quaternizing unit independently selected from the group consisting of C₁-C₈ linear alkyl, C₃-C₈ branched alkyl, benzyl, and mixtures thereof, preferably is methyl or benzyl, most preferably is methyl; and

X is a water soluble anion in sufficient amount to provide electronic neutrality. To a great degree, the counter ion X will be derived from the unit which is used to perform the quaternization. For example, if methyl chloride is used as the quaternizing agent, chlorine (chloride ion) will be the counter ion X. Bromine (bromide ion) will be the dominant counter ion in the case where benzyl bromide is the quaternizing agent.

A preferred zwitterionic hexamethylene diamine is of formula (V):

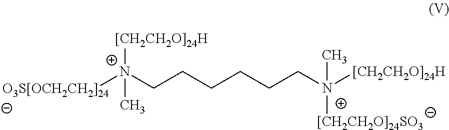

wherein the water soluble anion can comprise any suitable counterion.

In one preferred embodiment, the anti-microbial cleaning composition comprises:

a) from 0.03% to 0.5%, by weight of the composition, of a nonionic anti-microbial agent, wherein the anti-microbial agent is 4-4′-dichloro-2-hydroxy diphenyl ether; and

b) from 0.3% to 1.5%, by weight of the composition, of a soil dispersant, wherein the soil dispersant is a polyethyleneimine ethoxylate having a PEI as a backbone and a side chain of formula (I) bonded to a nitrogen atom of the PEI backbone,

-(EO)_{b}(PO)_{c} (I)
wherein the polyethyleneimine ethoxylate has a PEI backbone of MWₙ ranging from about 300 to about 3,000; b ranges from 15 to 35; and c is 0 or c ranges from 10 to 25.

### Adjunct Ingredients

The anti-microbial cleaning composition herein may comprise adjunct ingredients. Suitable adjunct materials include but are not limited to: anionic surfactants, nonionic surfactants, cationic surfactants, amphoteric surfactants, builders, chelating agents, rheology modifiers, dye transfer inhibiting agents, dispersants, enzymes, and enzyme stabilizers, catalytic materials, bleach activators, hydrogen peroxide, sources of hydrogen peroxide, preformed peracids, clay soil removal/anti-redeposition agents, brighteners, suds suppressors, dyes, photobleaches, perfumes, perfume microcapsules, structure elasticizing agents, fabric softeners, carriers, processing aids, hueing agents, structurants and/or pigments. In addition to the disclosure below, suitable examples of such other adjuncts and levels of use are found in U.S. Pat. Nos. 5,576,282, 6,306,812 B1 and 6,326,348 B1 that are incorporated by reference. The precise nature of these adjunct ingredients and the levels thereof in the cleaning composition will depend on the physical form of the composition and the nature of the cleaning operation for which it is to be used.

In one embodiment, the cleaning composition herein further comprises a surfactant selected from the group consisting of anionic surfactant, nonionic surfactant, cationic surfactant, amphoteric surfactant, and a combination thereof. Preferably the composition comprises from 3% to 50%, by weight of the composition, of an anionic surfactant, and from 0.1% to 10%, by weight of the composition, of a nonionic surfactant.

In one embodiment, the composition comprises an anionic surfactant. Non-limiting examples of anionic surfactants include: linear alkylbenzene sulfonate (LAS), preferably C₁₀-C₁₆ LAS; C₁₀-C₂₀ primary, branched-chain and random alkyl sulfates (AS); C₁₀-C₁₈ secondary (2,3) alkyl sulfates; sulphated fatty alcohol ethoxylate (AES), preferably C₁₀-C₁₈ alkyl alkoxy sulfates (AEₓS) wherein preferably x is from 1-30, more preferably x is 1-3; C₁₀-C₁₈ alkyl alkoxy carboxylates preferably comprising 1-5 ethoxy units; mid-chain branched alkyl sulfates as discussed in U.S. Pat. No. 6,020,303 and U.S. Pat. No. 6,060,443; mid-chain branched alkyl alkoxy sulfates as discussed in U.S. Pat. No. 6,008,181 and U.S. Pat. No. 6,020,303; modified alkylbenzene sulfonate (MLAS) as discussed in WO 99/05243, WO 99/05242, and WO 99/05244; methyl ester sulfonate (MES); and alpha-olefin sulfonate (AOS). Preferably, the composition comprises an anionic surfactant selected from the group consisting of LAS, AES, AS, and a combination thereof, more preferably selected from the group consisting of LAS, AES, and a combination thereof. In one preferred embodiment, the composition comprises an anionic surfactant system comprising AES and LAS. The total level of the anionic surfactant(s) may be from 3% to 50%, preferably present from 5% to 40%, more preferably from 10% to 30%, by weight of the composition, in the composition, by weight of the liquid detergent composition. In the execution where both AES and LAS are present in the composition, the weight ratio of the AES to LAS is from 0.1:1 to 10:1, preferably from 0.5:1 to 5:1, more preferably from 0.7:1 to 2:1.

In one embodiment, the composition herein comprises a nonionic surfactant, preferably an alkoxylated nonionic surfactant. Non-limiting examples of alkoxylated nonionic surfactants suitable for use herein include: C₁₂-C₁₈ alkyl ethoxylates, such as Neodol® nonionic surfactants available from Shell; C₆-C₁₂ alkyl phenol alkoxylates wherein the alkoxylate units are a mixture of ethyleneoxy and propyleneoxy units; C₁₂-C₁₈ alcohol and C₆-C₁₂ alkyl phenol condensates with ethylene oxide/propylene oxide block alkyl polyamine ethoxylates such as Pluronic® available from BASF; C₁₄-C₂₂ mid-chain branched alkyl alkoxylates, BAEx, wherein x is from 1-30, as discussed in U.S. Pat. No. 6,153,577, U.S. Pat. No. 6,020,303 and U.S. Pat. No. 6,093,856; alkylpolysaccharides as discussed in U.S. Pat. No. 4,565,647 Llenado; specifically alkylpolyglycosides as discussed in U.S. Pat. No. 4,483,780 and U.S. Pat. No. 4,483,779; polyhydroxy fatty acid amides as discussed in U.S. Pat. No. 5,332,528; and ether capped poly(oxyalkylated) alcohol surfactants as discussed in U.S. Pat. No. 6,482,994 and WO 01/42408. Also useful herein as nonionic surfactants are alkoxylated ester surfactants such as those having the formula R¹C(O)O(R₂O)nR³ wherein R¹ is selected from linear and branched C₆-C₂₂ alkyl or alkylene moieties; R² is selected from C₂H₄ and C₃H₆ moieties and R³ is selected from H, CH₃, C₂H₅ and C₃H₇ moieties; and n has a value between 1 and 20. Such alkoxylated ester surfactants include the fatty methyl ester ethoxylates (MEE) and are well-known in the art; see for example U.S. Pat. No. 6,071,873; U.S. Pat. No. 6,319,887; U.S. Pat. No. 6,384,009; U.S. Pat. No. 5,753,606; WO 01/10391, WO 96/23049.

In one embodiment, the alkoxylated nonionic surfactant herein is C₆-C₂₂ alkoxylated alcohol, preferably C₈-C₁₈ alkoxylated alcohol, more preferably C₁₂-C₁₆ alkoxylated alcohol. The C₆-C₂₂ alkoxylated alcohol is preferably an alkyl alkoxylated alcohol with an average degree of alkoxylation of from 1 to 50, preferably 3 to 30, more preferably from 5 to 20, even more preferably from 5 to 9. The alkoxylation herein may be ethoxylation, propoxylation, or a mixture thereof, but preferably is ethoxylation. In one embodiment, the alkoxylated nonionic surfactant is C₆-C₂₂ ethoxylated alcohol, preferably C₈-C₁₈ alcohol ethoxylated with an average of 5 to 20 moles of ethylene oxides, more preferably C₁₂-C₁₆ alcohol ethoxylated with an average of 5 to 9 moles of ethylene oxides. The most preferred alkoxylated nonionic surfactant is C₁₂-C₁₅ alcohol ethoxylated with an average of 7 moles of ethylene oxide, e.g., Neodol®25-7 commercially available from Shell.

In one preferred embodiment, the anti-microbial cleaning composition herein further comprises, by weight of the composition, from 3% to 50%, preferably from 5% to 45%, more preferably from 10% to 40%, of an anionic surfactant, and from 0.1% to 10%, preferably from 0.3% to 7%, more preferably from 0.5% to 5%, of a nonionic surfactant.

In one embodiment, the composition herein comprises a cationic surfactant. Non-limiting examples of cationic surfactants include: the quaternary ammonium surfactants, which can have up to 26 carbon atoms include: alkoxylate quaternary ammonium (AQA) surfactants as discussed in U.S. Pat. No. 6,136,769; dimethyl hydroxyethyl quaternary ammonium as discussed in U.S. Pat. No. 6,004,922; dimethyl hydroxyethyl lauryl ammonium chloride; polyamine cationic surfactants as discussed in WO 98/35002, WO 98/35003, WO 98/35004, WO 98/35005, and WO 98/35006; cationic ester surfactants as discussed in U.S. Pat. Nos. 4,228,042, 4,239,660 4,260,529 and U.S. Pat. No. 6,022,844; and amino surfactants as discussed in U.S. Pat. No. 6,221,825 and WO 00/47708, specifically amido propyldimethyl amine (APA).

In one embodiment, the composition herein comprises an amphoteric surfactant. Non-limiting examples of amphoteric surfactants include: derivatives of secondary and tertiary amines, derivatives of heterocyclic secondary and tertiary amines, or derivatives of quaternary ammonium, quaternary phosphonium or tertiary sulfonium compounds. Preferred examples include: betaine, including alkyl dimethyl betaine and cocodimethyl amidopropyl betaine, C8 to C18 (or C12 to C18) amine oxides and sulfo and hydroxy betaines, such as N-alkyl-N,N-dimethylamino-1-propane sulfonate where the alkyl group can be C8 to C18, or C10 to C14.

Preferably, the amphoteric surfactant herein is selected from water-soluble amine oxide surfactants. A useful amine oxide surfactant is:

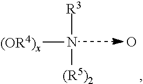

where R³ is a C₈₋₂₂ alkyl, a C₈₋₂₂ hydroxyalkyl, or a C₈₋₂₂ alkyl phenyl group; each R⁴ is a C₂₋₃ alkylene, or a C₂₋₃₂ hydroxyalkylene group; x is from 0 to about 3; and each R⁵ is a C₁₋₃ alkyl, a C₁₋₃ hydroxyalkyl, or a polyethylene oxide containing from about 1 to about 3 EOs. Preferably, the amine oxide surfactant may be a C₁₀₋₁₈ alkyl dimethyl amine oxide or a C₈₋₁₂ alkoxy ethyl dihydroxy ethyl amine oxide.

In one embodiment, the composition herein comprises a rheology modifier (also referred to as a “structurant” in certain situations), which functions to suspend and stabilize the microcapsules and to adjust the viscosity of the composition so as to be more applicable to the packaging assembly. The rheology modifier herein can be any known ingredient that is capable of suspending particles and/or adjusting rheology to a liquid composition, such as those disclosed in U.S. Patent Application Nos. 2006/0205631A1, 2005/0203213A1, and U.S. Pat. Nos. 7,294,611, 6,855,680. Preferably the rheology modifier is selected from the group consisting of hydroxy-containing crystalline material, polyacrylate, polysaccharide, polycarboxylate, alkali metal salt, alkaline earth metal salt, ammonium salt, alkanolammonium salt, C₁₂-C₂₀ fatty alcohol, di-benzylidene polyol acetal derivative (DBPA), di-amido gallant, a cationic polymer comprising a first structural unit derived from methacrylamide and a second structural unit derived from diallyl dimethyl ammonium chloride, and a combination thereof. Preferably, the rheology modifier is a hydroxy-containing crystalline material generally characterized as crystalline, hydroxyl-containing fatty acids, fatty esters and fatty waxes, such as castor oil and castor oil derivatives. More preferably the rheology modifier is a hydrogenated castor oil (HCO).

In a highly preferred embodiment, the anti-microbial cleaning composition of the present invention comprises:

a) from 0.03% to 0.5%, by weight of the composition, of the anti-microbial agent, wherein the anti-microbial agent is 4-4′-dichloro-2-hydroxy diphenyl ether;

b) from 0.3% to 1%, by weight of the cleaning composition, of the soil dispersant, wherein the soil dispersant is a polyethyleneimine ethoxylate having a PEI as a backbone and a side chain of formula (I) bonded to a nitrogen atom of the PEI backbone,

-(EO)_{b}(PO)_{c} (I)

wherein the polyethyleneimine ethoxylate has a PEI backbone of MWₙ ranging from about 300 to about 3,000; b ranges from 15 to 35; and c is 0 or c ranges from 10 to 25, but preferably is 0;

c) from 10% to 40%, by weight of the composition, of an anionic surfactant system comprising AES and LAS; and

d) from 0.5% to 5%, by weight of the composition, of a nonionic surfactant, wherein the nonionic surfactant is C₁₂-C₁₆ alcohol ethoxylated with an average of 5 to 9 moles of ethylene oxides.

### Composition Preparation

The cleaning composition of the present invention is generally prepared by conventional methods such as those known in the art of making cleaning compositions. Such methods typically involve mixing the essential and optional ingredients in any desired order to a relatively uniform state, with or without heating, cooling, application of vacuum, and the like, thereby providing cleaning compositions containing ingredients in the requisite concentrations.

### Water-Soluble Pouch

In one embodiment, the anti-microbial cleaning composition herein is contained within a water-soluble film thereby forming a water-soluble pouch. The pouch may be of such a size that it conveniently contains either a unit dose amount of the composition herein, suitable for the required operation, for example one wash, or only a partial dose, to allow a user greater flexibility to vary the amount used, e.g., depending on the size or degree of soiling of the wash load.

The water-soluble film of the pouch preferably comprises a polymer. The film can be obtained from methods known in the art, e.g., by casting, blow molding, extrusion molding, injection molding of the polymer. Non-limiting examples of the polymer for making the water-soluble film include: polyvinyl alcohols (PVAs), polyvinyl pyrrolidone, polyalkylene oxides, (modified) cellulose, (modified) cellulose-ethers or -esters or -amides, polycarboxylic acids and salts including polyacrylates, copolymers of maleic/acrylic acids, polyaminoacids or peptides, polyamides including polyacrylamide, polysaccharides including starch and gelatine, natural gums such as xanthum and carragum. Preferably, the water-soluble film comprises a polymer selected from the group consisting of polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, polyvinyl alcohols, hydroxypropyl methyl cellulose (HPMC), and a combination thereof. Most preferably, the water-soluble film comprises polyvinyl alcohol, e.g., M8639 available from MonoSol. Suitable polymers for making the water-soluble film of the pouch can be found in U.S. Pat. No. 6,995,126.

The pouch herein may comprise a single compartment or multiple compartments, preferably comprise multiple compartments, e.g., two compartments or three compartments. In the multi-compartment execution, one or more of the multiple compartments comprise the aforementioned anti-microbial cleaning composition. Preferably, the pouch comprises multiple films which form the multiple compartments, i.e., the inner volume of the multiple films is divided into the multiple compartments. Examples of these multi-compartment pouches are described in U.S. Pat. Nos. 4,973,416, 5,224,601, and 8,066,818.

The pouch of the present invention can be made by any suitable processes known in the art. Example processes of making the pouch can be found in U.S. Pat. Nos. 6,995,126, 7,127,874, 8,156,713, 7,386,971, 7,439,215, and US Patent Publication No. 2009/199877.

### Method of Use

Another aspect of the present invention is directed to a method of using the cleaning composition to treat a situs, particularly a fabric, with an anti-microbial benefit. The method comprises the step of administering from 5 g to 120 g of the aforementioned cleaning composition into a washing basin comprising water to form a washing solution. The washing solution in a laundry washing basin herein preferably has a volume from 1 L to 50 L, alternatively from 1 L to 20 L for hand washing and from 20 L to 50 L for machine washing. Preferably, the anti-microbial benefit herein is determined by the JISL 1902 method. The temperatures of the washing solution preferably range from 5° C. to 60° C.

The dosing amount in the method herein may be different depending on the washing type. In one embodiment, the method comprises administering from 5 g to 60 g of the cleaning composition into a hand washing basin (e.g., 4 L). In an alternative embodiment, the method comprises administering from 60 g to 120 g of the cleaning composition into a washing machine (e.g., 30 L).

Preferably, the method herein further comprises the step of contacting a fabric with the washing solution, wherein the fabric is in need of an anti-microbial treatment. For example, the presence of Gram positive bacteria and/or Gram negative bacteria is suspected on the fabric. The step of contacting the fabric with the washing solution is preferably after the step of administering the cleaning composition in a washing basin. The method may further comprise the step of contacting a fabric with the cleaning composition prior to the step of administering the cleaning composition in a washing basin, i.e., pre-treat the fabric with the cleaning composition for certain time, preferably from 1 minute to 10 minutes.

### Test Method

The anti-microbial efficacy for laundry detergent compositions is determined by the method as defined in the JISL 1902 method and described hereinafter.

1. Microorganism Preparation:

A. Aseptically add certain amount of nutrient broth into a lyophilized culture of Staphylococcus aureus or Klebsiella pneumoniae. Dissolve and suspend the culture in the nutrient broth to obtain a suspension. Streak a loop of the suspension onto a nutrient agar plate, and incubate at 37° C. for 24 hours to obtain a first generation subculture of bacterial suspension. Transfer a loop of the first generation subculture of bacterial suspension into 20 mL of nutrient broth with shaking, and incubate at 37° C. for 24 hours to obtain a second generation subculture of bacterial suspension. Transfer 0.4 mL of the second generation subculture of bacterial suspension into another 20 mL of nutrient broth with shaking, and incubate at 37° C. for 3 hours to obtain a third generation subculture of bacterial suspension.

B. Dilute the third generation subculture of bacterial suspension by 1/20 diluted nutrient broth to 1×105 cells/mL to obtain a working culture.

C. Store the working culture at 4° C. The working culture cannot be stored overnight.

2. Fabric Washing:

A. Boil two fabric strips each having a width of 5 cm and length of 2.5 m (32 yarn/cm×32 yarn/cm, 100% plain weave cotton) in 3 L of a solution for 1 hour. The solution is prepared by 1.5 g of a nonionic soaked agent, 1.5 g of sodium carbonate, and 3000 mL of distilled water. The nonionic soaked agent is prepared by 5.0 g of alkylphenol ethoxylate, 5 g of sodium carbonate, and 1000 mL of distilled water. Rinse the fabric strips in boiled deionized water for 5 minutes. Place the fabric strips in cool deionized water for 5 minutes, and indoor dry. One fabric strip serves as a test fabric strip for following steps 2B-2I, and the other fabric strip is used as control (without experiencing steps 2B-2I).

B. Fix one end of the test fabric strip obtained from step 2A onto a stainless steel spindle at an outer position along the horizontal extension of the stainless steel spindle. The stainless steel spindle has 3 horizontal stands that are connected to one another. Wrap the test fabric strip around the 3 horizontal stands of the stainless steel spindle with sufficient tension to obtain a fabric wrapped spindle having 12 laps of fabric. Fix the other end of the test fabric strip onto the outer lap of the 12 laps of fabric via a pin. Sterilize the fabric wrapped spindle with pressure steam at 121° C. for 15 minutes.

C. Dissolve 5.903 g of calcium chloride dihydrate and 2.721 g of magnesium chloride hexahydrate in 100 mL of distilled water, and then sterilize the mixture with pressure steam at 121° C. for 20 minutes. Add 1 mL of the mixture into 1 L of distilled water to obtain a hard water solution.

D. Add sufficient amount of sample into 1 L of the hard water solution obtained from step 2C to obtain a solution having a concentration of 2069 ppm. Mix the solution by a magnetic stirrer for 4 minutes. Distribute 250 mL of the mixed solution into an exposure chamber to obtain a washing solution. Place the exposure chamber in a water bath and achieve the test temperature of (25±1°) C. The exposure chamber is then sterilized with pressure steam at 121° C. for 15 minutes.

E. Aseptically soak the fabric wrapped spindle obtained from step 2B into the washing solution in the exposure chamber, and close the exposure chamber with a lid.

F. Fix the exposure chamber onto a tumbler. Rotate the tumbler for 10 minutes. Then remove the fabric wrapped spindle from the exposure chamber. Place the fabric wrapped spindle in Haier iwash-1p Top Load Washing Machine and rinse for 2 minutes.

G. Discard the washing solution from the exposure chamber, and then add 250 mL of sterilized distilled water into the exposure chamber. Soak the rinsed fabric wrapped spindle in the newly added distilled water in the exposure chamber. Rotate the tumbler for 3 minutes.

H. Repeat step 2G.

I. Aseptically remove the fabric wrapped spindle out of the exposure chamber and remove the test fabric strip from the spindle. Air dry the test fabric strip overnight.

3. Fabric Incubation:

A. Cut the washed test fabric strip obtained from step 2I to square pieces having a side length of 2 cm. 3 sets of 0.4 g of the pieces serve as specimens for the following steps.

B. Put each set of specimens into a vial, and then sterilize the specimens with pressure steam at 121° C. for 15 minutes. After the sterilization, dry the specimens for 1 hour in a clean bench without a cap.

C. Inoculate 0.2 mL of the working culture obtained from step 1C onto each dried specimen. Incubate the vials containing the inoculated specimens at 37° C. for 18 hours.

D. Extract survivors on the incubated specimens, plate with nutrient agar, and incubate at 37° C. for 24-48 hours. Count the total colony-forming units (CFU) of each set of specimens, and obtain average results of the 3 sets. Take the log 10 value of CFU value as Mb.

E. In steps 3A-3D, use the fabric strip obtained from step 2A (that does not experience steps 2B-2I) as control. Take the log 10 value of CFU value as Ma.

4. Calculation of Bacteriostatic Activity Value:

Bacteriostatic Activity Value=Mb−Ma

A Bacteriostatic Activity Value of greater than 2.2 represents acceptable anti-microbial efficacy, of greater than 2.5 represents good anti-microbial efficacy, and of greater than 3.0 represents excellent anti-microbial efficacy. And a Bacteriostatic Activity Value of lower then 2.2 indicates unacceptable poor anti-microbial efficacy.

### EXAMPLE

The Examples herein are meant to exemplify the present invention but are not used to limit or otherwise define the scope of the present invention. Examples 1A-1C and 2A-2B are examples according to the present inventions, and Examples 2C-2D are comparative examples.

### Examples 1A-1C

### Formulations of Liquid Laundry Detergent Compositions

The following liquid laundry detergent compositions shown in Table 1 are made comprising the listed ingredients in the listed proportions (weight %).

TABLE 1

| | 1A | 1B | 1C |
|---|---|---|---|
| C₁₂-₁₄AE₁₋₃S | 13 | 8.3 | 10 |
| C₁₁-₁₃LAS | 3 | 5.5 | 6.5 |
| Neodol ®25-7 a | 1.4 | 1.2 | 1.4 |
| Citric acid | 0 | 2 | 1.7 |
| Boric acid | 0 | 2 | 1.9 |
| C₁₂-C₁₈ fatty acid | 1.5 | 1.2 | 1.3 |
| Na-DTPA b | 0.06 | 0.2 | 0.4 |
| 1,2 propanediol | 0 | 1.2 | 2.5 |
| Calcium chloride | 0 | 0 | 0.06 |
| Silicone emulsion | 0 | 0.0025 | 0.0025 |
| Monoethanolamine | 0.07 | 0 | 0 |
| Sodium polyacrylate | 1.4 | 0 | 0 |
| NaOH | Up to pH 8 | Up to pH 8 | Up to pH 8 |
| Polyethyleneimine | 1 | 0 | 0 |
| ethoxylate c | | | |
| Polyethyleneimine | 0 | 1 | 0 |
| ethoxylate d | | | |
| Zwitterionic | 0 | 0 | 1 |
| hexamethylene | | | |
| diamine e | | | |
| Tinosan ®HP100 f | 0.04 | 0.04 | 0.04 |
| Brightener | 0 | 0.06 | 0.06 |
| Protease | 0 | 0 | 0.45 |
| Amylase | 0 | 0 | 0.08 |
| Dye | 0 | 0.002 | 0.002 |
| Perfume oil | 0 | 0.6 | 0.6 |
| Water | Add to 100 | Add to 100 | Add to 100 |

a Neodol ®25-7 is C₁₂-C₁₅ alcohol ethoxylated with an average of 7 moles of ethylene oxide as a nonionic surfactant, available from Shell
b penta sodium salt diethylene triamine penta acetic acid as a chelant
c polyethyleneimine ethoxylate having a PEI backbone of MWₙ of about 600 and side chains of (EO)₂₀
d polyethyleneimine ethoxylate having a PEI backbone of MWₙ of about 600 and side chains of (EO)₂₀(PO)₅
e zwitterionic hexamethylene diamine of formula (V)
f Tinosan ®HP100 is 4-4′-dichloro-2-hydroxy diphenyl ether, available from BASF

### Example 2A-2D

### Formulations of Liquid Laundry Detergent Compositions

The following liquid laundry detergent compositions shown in Table 2 are made comprising the listed ingredients in the listed proportions (weight %).

TABLE 2

| | | | Compar- | Compar- |
|---|---|---|---|---|
| | | | ative | ative |
| | 2A | 2B | 2C | 2D |
| C₁₁-C₁₃ LAS | 3.0 | 12.3 | 3.0 | 17.8 |
| C₁₂-C₁₄AE₃S | 1.4 | 17.8 | 1.4 | 25.8 |
| Neodol ®25-7 a | 0.5 | 8.3 | 11.4 | 11.4 |
| Citric acid | 0.5 | 0.5 | 0.5 | 0.5 |
| C₁₂-C₁₈ fatty acid | 0.5 | 2.0 | 0.5 | 0.5 |
| Polyethyleneimine | 0.2 | 1.1 | 4.2 | 4.2 |
| ethoxylate b | | | | |
| Sodium cumene sulphonate | 1.3 | 1.3 | 1.3 | 1.3 |
| 1,2 propanediol | 9.5 | 9.5 | 9.5 | 9.5 |
| Monoethanolamine | 1.2 | 3.2 | 1.2 | 3.9 |
| Tinosan ®HP100 c | 0.09 | 0.09 | 0.09 | 0.09 |
| Water | Add | Add | Add | Add |
| | to 100 | to 100 | to 100 | to 100 |

a Neodol ®25-7 is C12-C115 alcohol ethoxylated with an average of 7 moles of ethylene oxide as a nonionic surfactant, available from Shell
b polyethyleneimine ethoxylate having a PEI backbone of MWₙ of about 600 and side chains of (EO)₂₀
c Tinosan ®HP100 is 4-4′-dichloro-2-hydroxy diphenyl ether, available from BASF

Preparation of the liquid laundry detergent compositions of Examples 1A-1C and 2A-2D.

The liquid laundry detergent compositions of Examples 1A-1C and 2A-2D are prepared by the following steps:

a) mixing a combination of NaOH (if any) and water in a batch container by applying a shear of 200 rpm;

b) adding citric acid (if any), boric acid (if any), and C₁₁-C₁₃ LAS into the batch container, keeping on mixing by applying a shear of 200 rpm;

c) cooling down the temperature of the combination obtained in step b) to 25° C.;

d) adding C₁₂₋₁₄AE₁₋₃S, Na-DTPA (if any), Neodol®25-7, C₁₂-C₁₈ fatty acid, 1,2 propanediol (if any), monoethanolamine (if any), calcium chloride (if any), sodium cumene sulphonate (if any), silicone emulsion (if any), sodium polyacrylate (if any), polyethyleneimine ethoxylate (if any), zwitterionic hexamethylene diamine (if any), and Tinosan®HP100 into the batch container, mixing by applying a shear of 250 rpm until the combination is homogeneously mixed, and adjusting pH to 8;

e) adding brightener (if any), protease (if any), amylase (if any), dye (if any), and perfume oil (if any) into the batch container, mixing by applying a shear of 250 rpm, thus forming a liquid laundry detergent composition,

wherein each ingredient in the composition is present in the level as specified for Examples 1A-1C and 2A-2D in Tables 1 and 2.

### Comparative Data of Examples 2A-2D on Anti-Microbial Efficacy

Comparative experiments of measuring the anti-microbial efficacy of the compositions of Examples 2A-2B and Comparative Examples 2C-2D are conducted, according to the JISL 1902 method as described hereinabove. Specifically, the composition is added in step 2D of the method as sample. Table 3 shows Bacteriostatic Activity Values against Staphylococcus aureus (a Gram positive bacterium), and Table 4 shows Bacteriostatic Activity Values against Klebsiella pneumoniae (a Gram negative bacterium).

TABLE 3

| | Bacteriostatic Activity Value against |
|---|---|
| Example | Staphylococcus aureus |
| 2A | 4.2 |
| 2B | 3.9 |
| Comparative 2C | 3.3 |
| Comparative 2D | 2.9 |

TABLE 4

| | Bacteriostatic Activity Value against |
|---|---|
| Example | Klebsiella pneumoniae |
| 2A | 2.9 |
| Comparative 2C | 2.1 |

As shown in Tables 3 and 4, the laundry detergent compositions according to the present invention (Examples 2A and 2B) demonstrate improved anti-microbial efficacy over the comparative compositions (Comparative Examples 2C and 2D), against both Gram positive and Gram negative bacteria. In particular, the laundry detergent compositions according to the present invention deliver excellent anti-microbial efficacy against Staphylococcus aureus, which is frequently found on human skin.

Unless otherwise indicated, all percentages, ratios, and proportions are calculated based on weight of the total composition. All temperatures are in degrees Celsius (° C.) unless otherwise indicated. All measurements made are at 25° C., unless otherwise designated. All component or composition levels are in reference to the active level of that component or composition, and are exclusive of impurities, for example, residual solvents or by-products, which may be present in commercially available sources.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An anti-microbial cleaning composition, comprising:
a) from about 0.001% to about 3%, by weight of the cleaning composition, of a nonionic anti-microbial agent; and
b) from about 0.1% to about 3%, by weight of the composition, of a soil dispersant comprising an alkylene amine backbone and a side chain bonded to the nitrogen atom of the alkylene amine backbone, wherein the side chain is of formula (I),
-(EO)_{b}(PO)_{c} (I)
wherein b ranges from 3 to 60, and c ranges from 0 to 60.

2. The composition according to claim 1, wherein said nonionic anti-microbial agent is a diphenyl ether.

3. The composition according to claim 2, wherein said nonionic anti-microbial agent is a hydroxy diphenyl ether compound of formula (II): 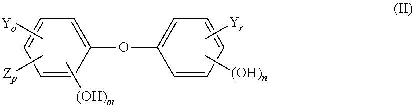
wherein:
each Y is independently selected from chlorine, bromine, or fluorine,
each Z is independently selected from SO₂H, NO₂, or C₁-C₄ alkyl,
r is 0, 1, 2, or 3,
o is 0, 1, 2, or 3,
p is 0, 1, or 2,
m is 1 or 2, and
n is 0 or 1.

4. The composition according to claim 3, wherein said nonionic anti-microbial agent is selected from the group consisting of 4-4′-dichloro-2-hydroxy diphenyl ether, 2,4,4′-trichloro-2′-hydroxy diphenyl ether, and a combination thereof.

5. The composition according to claim 4, wherein said nonionic anti-microbial agent is 4-4′-dichloro-2-hydroxy diphenyl ether.

6. The composition according to claim 1, wherein said hydrophobic soil dispersant comprises a compound selected from the group consisting of:
a polyethyleneimine ethoxylate, having a polyethyleneimine (PEI) as a backbone and a side chain of formula (I) bonded to a nitrogen atom of the PEI backbone
-(EO)_{b}(PO)_{c} (I)
wherein b ranges from 3 to 60, and c ranges from 0 to 60;
a compound of formula (III), 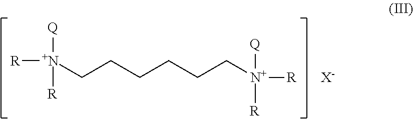
wherein R is an ethyleneoxy unit of formula (IV):
-(EO)ₙR⁴ (IV)
wherein n ranges from 10 to 40; R⁴ is hydrogen, an anionic unit, or a combination thereof Q is a quaternizing unit independently selected from the group consisting of C₁-C₈ linear alkyl, C₃-C₈ branched alkyl, benzyl, and mixtures thereof; and X is a water soluble anion; and
a combination thereof.

7. The composition according to claim 6, wherein the polyethyleneimine ethoxylate has a PEI backbone of an average number-average molecular weight, MWₙ, ranging from about 300 to about 3,000; b ranges from 15 to 35; and c is 0.

8. The composition according to claim 6, wherein the polyethyleneimine ethoxylate has a PEI backbone of MWₙ ranging from about 300 to about 3,000; b ranges from 15 to 35; and c ranges from 10 to 25.

9. The composition according to claim 6, wherein compound of formula (III) is of formula (V):

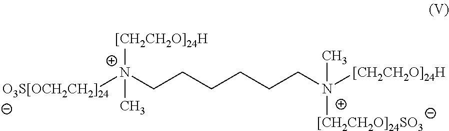

10. The composition according to claim 1, wherein said nonionic anti-microbial agent is present from about 0.01% to about 1%, more preferably from about 0.03% to about 0.5%, by weight of the cleaning composition, and said soil dispersant is present from about 0.2% to about 2%, more preferably from about 0.3% to about 1.5%, by weight of the composition.

11. The composition according to claim 1, further comprising from about 3% to about 50%, by weight of the composition, of an anionic surfactant, and from about 0.1% to about 10%, by weight of the composition, of a nonionic surfactant.

12. The composition according to claim 1, wherein the composition provides at least a log 2.2 reduction against Staphylococcus aureus and/or Klebsiella pneumoniae after a 10 minutes contact time in a 2069 ppm aqueous solution as determined by the JISL 1902 method.

13. The composition according to claim 1, comprising:
a) from about 0.03% to about 0.5%, by weight of the cleaning composition, of said nonionic anti-microbial agent, wherein said nonionic anti-microbial agent is 4-4′-dichloro-2-hydroxy diphenyl ether;
b) from about 0.3% to about 1.5%, by weight of the cleaning composition, of said soil dispersant, wherein said soil dispersant is a polyethyleneimine ethoxylate having a PEI as a backbone and a side chain of formula (I) bonded to a nitrogen atom of the PEI backbone,
-(EO)_{b}(PO)_{c} (I)
wherein the polyethyleneimine ethoxylate has a PEI backbone of MWₙ ranging from about 300 to about 3,000; b ranges from 15 to 35; and c is 0;
c) from about 10% to about 40%, by weight of the composition, of an anionic surfactant system comprising an alkyl ethoxy sulfate (AES) and a linear alkylbenzene sulfonate (LAS); and
d) from about 0.5% to about 5%, by weight of the composition, of a nonionic surfactant, wherein said nonionic surfactant is C₁₂-C₁₆ alcohol ethoxylated with average of 5 to 9 moles of ethylene oxides.

14. The composition according to claim 1, wherein the composition is contained within a water-soluble film, preferably said water-soluble film comprises polyvinyl alcohol.
